(19) United States
(12) Patent Application Publication
(10) Pub. No.: US 2020/0204026 A1
(43) Pub. Date: Jun. 25, 2020

(54) Asymmetrical Winding Configuration For An Electric Motor Drive

(71) Applicant: Massachusetts Institute of Technology, Cambridge, MA (US)

(72) Inventors: James L. KIRTLEY, JR., Brookline, MA (US); Ho Tin LEE, Cambridge, MA (US)

(21) Appl. No.: 16/227,106

(22) Filed: Dec. 20, 2018

(51) Int. Cl. H02K 3/28; H02K 1/17; H02K 1/24; H02K 21/44

(52) U.S. Cl. CPC H02K 3/28; H02K 1/17; H02K 29/03; H02K 21/44; H02K 1/24

(57) ABSTRACT

Described is a Vernier permanent-magnet (VPM) motor having a rotor, a stator, an arrangement of permanent magnets disposed on the stator and armature windings having an asymmetric winding arrangement.

### TECHNICAL FIELD

This disclosure generally relates to an electric motor and more particularly to a winding configuration for an electric motor.

### BACKGROUND

As is known in the art, one type of electric motor is referred to as a Vernier permanent-magnet motor. A Vernier permanent-magnet motor includes a rotor, a stator, an arrangement of permanent magnets and armature windings.

As is also known, unlike electric motors that employ identical numbers of stator pole-pairs and rotor pole-pairs, a Vernier permanent-magnet motor instead employs unequal numbers of stator pole-pairs and rotor pole-pairs.

As illustrated in FIG. 1, a conventional winding configuration for a Vernier permanent-magnet motor employs a symmetrical winding pattern such that the armature windings are wound as ABC-ABC-ABC-ABC, where A, B and C denote phase-A, phase-B and phase-C of the armature windings, respectively.

A is also known, the use of an unequal number of stator pole-pairs and rotor pole-pairs in a Vernier permanent-magnet motor results in the VPM motor having a reduced cogging torque. There still exists, however, an undesirable torque pulsation characteristic (sometimes referred to as a torque “ripple”) which is primarily produced by a symmetrical winding configuration. Thus, one drawback to a Vernier permanent-magnet motor is the existence of such a torque ripple characteristic.

It would, therefore, be desirable to provide a Vernier permanent-magnet motor having an improved torque pulsation characteristic (i.e. a torque ripple which is relatively low (or ideally eliminated), compared with the torque ripple of a conventional Vernier permanent magnet motor.

### SUMMARY

In accordance with the concepts, systems and techniques described herein, a Vernier permanent-magnet motor (VPM) comprises a rotor, a stator and an armature winding provided having an asymmetrical winding pattern.

With this particular arrangement, a Vernier permanent-magnet (VPM) motor having a torque ripple characteristic which is relatively low compared with the torque ripple characteristic of a conventional Vernier permanent magnet motor is provided. Such a low torque ripple characteristic is achieved through the use of the asymmetrical winding pattern.

In embodiments, a Vernier permanent magnet motor operating with three phases (A, B, C), twelve (12) stator-rotor pole pairs and three armature windings may be provided having an asymmetrical winding pattern. In embodiments, the armature windings may be asymmetrically wound as A-BBB-C-AAA-B-CCC.

It should, of course, be appreciated that in embodiments, any number of pole-pairs, and thus asymmetrical winding patterns, may be used. The particular asymmetrical winding pattern used in any particular application will depend upon the particular VPM motor design which, in turn, depends upon the needs of the particular application for which the VPM motor is being designed.

In embodiments, the Vernier permanent-magnet (VPM) motor having an asymmetrical winding pattern may be provided as any of: an inner-rotor VPM (IR-VPM) motor; an outer-rotor VPM (OR-VPM) motor; or an OR consequent-pole VPM (OR-CP-VPM) motor. Such motors having the asymmetrical windings are suitable for use in hybrid electric vehicle (HEV) applications.

The details of one or more embodiments of which illustrate the concepts described herein are outlined in the accompanying drawings and the description below. Other features, objects, and advantages of the concepts disclosed herein will be apparent from the description and drawings, and from the claims.

In accordance with one aspect of the concepts described herein, a Vernier permanent-magnet (VPM) motor comprises a rotor, a stator disposed proximate the rotor, an array of permanent magnets disposed on one of the stator and rotor and armature windings coupled to the stator with the armature windings having an asymmetric winding pattern

With this particular arrangement, a VPM motor having a torque pulsation characteristic (i.e. a torque ripple characteristic) which is relatively low (or ideally eliminated), compared with a torque ripple characteristic of a conventional Vernier permanent magnet motor is provided.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the following claims.

In embodiments, the VPM motor is provided such that the rotor is an inner rotor.

In embodiments, the VPM motor is provided such that the array of permanent magnets are disposed on the stator.

In embodiments, the VPM motor is provided such that the armature windings are provided as three-phase armature windings having an asymmetric winding arrangement.

In embodiments, the VPM motor is provided having an N/M pole topology where N and M are both integers greater than 2.

In embodiments, the VPM motor is provided having a twelve-stator-slot/seven-rotor-pole-pair topology.

In embodiments, the VPM motor is provided having a twenty-four-stator-slot/fourteen-rotor-pole-pair topology.

In embodiments, the VPM motor includes an armature winding provided as an overlapping-winding arrangement.

In embodiments, the VPM motor is provided such that the rotor is an outer rotor.

In embodiments, the VPM motor is provided such that the array of permanent magnets are disposed on the stator.

In embodiments, the VPM motor is provided such that the armature windings are provided as three-phase armature windings having an asymmetric winding arrangement.

In embodiments, the VPM motor is provided having a twelve-stator-slot/seven-rotor-pole-pair topology.

In embodiments, the VPM motor is provided having a twenty-four-stator-slot/fourteen-rotor-pole-pair topology.

In embodiments, the VPM motor is provided such that the armature winding is provided having a concentrated-winding arrangement.

Accordingly, in view of the above, it should now be apparent to one of ordinary skill in the art that VPM motors may include one or more of the above-noted features independently or in combination with one or more other features to provide combinations not specifically recited herein.

### BRIEF DESCRIPTION OF THE DRAWINGS

The foregoing features may be more fully understood from the following description of the drawings in which:

FIG. 1 is a diagram which illustrates a conventional winding pattern for a Vernier permanent-magnet motor;

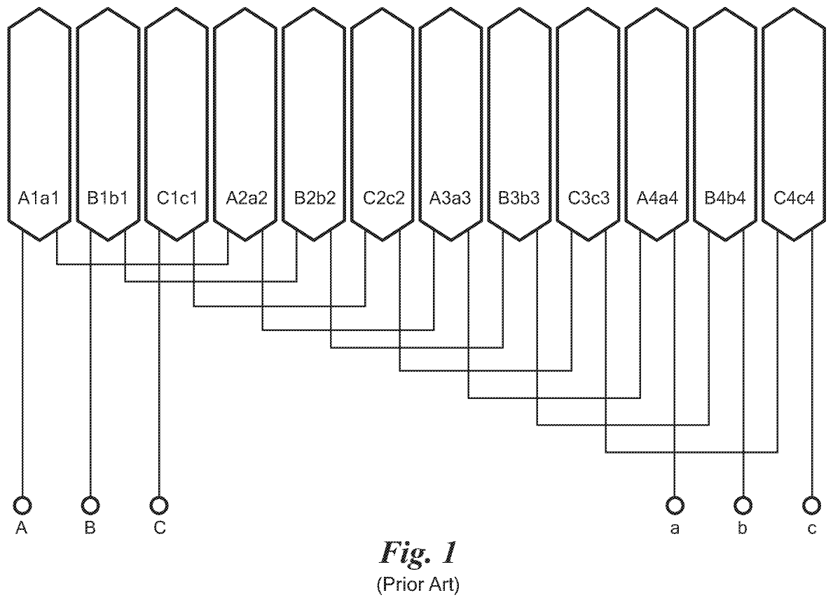

FIG. 2 is a top view of a Vernier permanent-magnet motor having an asymmetrical winding pattern; and

FIG. 3 is a diagram which illustrates an asymmetrical winding pattern for the Vernier permanent-magnet motor of FIG. 2; and

FIG. 4 is a diagram which illustrates an asymmetrical winding pattern for an alternate embodiment of a Vernier permanent-magnet motor.

### DETAILED DESCRIPTION

All relative descriptions herein, such as left, right, up, and down, are with reference to the figures, and not meant in a limiting sense. Additionally, for clarity, certain common items and circuitry, such as integrated circuits, resistors, capacitors, transistors, and the like, have not been included in some of the figures, as can be appreciated by those of ordinary skill in the pertinent art. Unless otherwise specified, the illustrated embodiments may be understood as providing example features of varying detail of certain embodiments. It should thus be appreciated that, unless otherwise specified, features, components, modules, elements, and/or aspects of the illustrations can be otherwise combined, interconnected, sequenced, separated, interchanged, positioned, and/or rearranged without materially departing from the disclosed concepts, systems, or methods described herein. Additionally, the shapes and sizes of components are intended to be only illustrative and unless otherwise specified, can be altered without materially affecting or limiting the scope of the concepts sought to be protected herein.

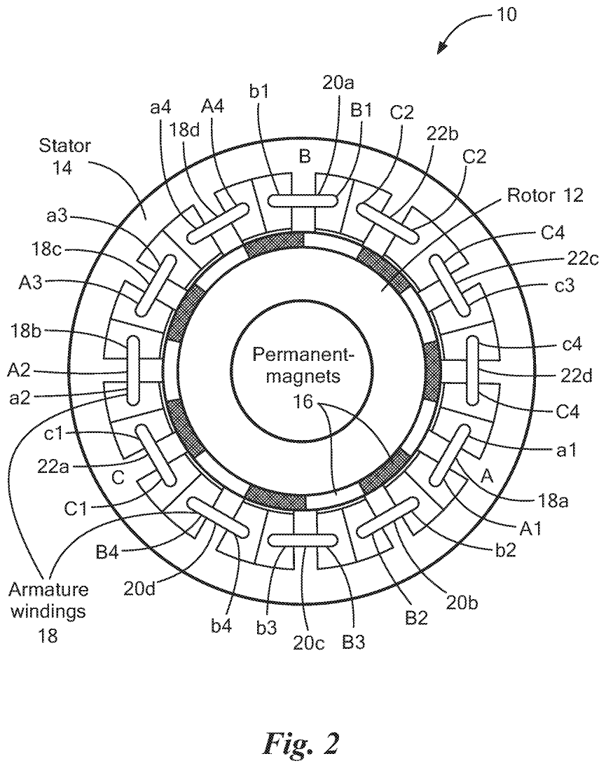

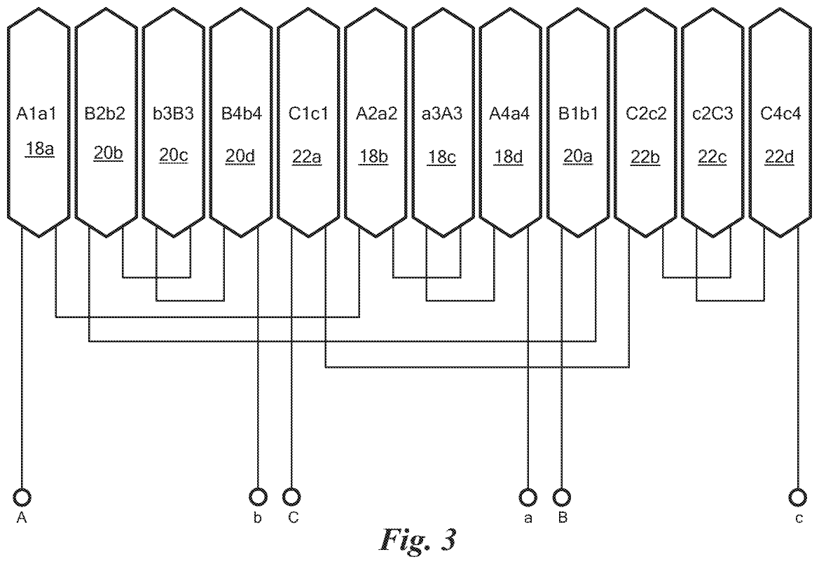

Referring now to FIGS. 2 and 3 in which like elements are provided having like reference designations, a Vernier permanent-magnet (VPM) motor 10 includes an inner rotor 12, a stator 14, an arrangement (or array) of permanent magnets (generally denoted 16) disposed on said stator, three-phase armature windings 18a-18d, 20a-20d, 22a-22d.

The illustrative embodiment of FIG. 2 includes fourteen magnets and a 12/7 pole topology (twelve-stator-slot/seven-rotor-pole topology i.e. a seven rotor pole pair). The armature windings are installed based upon an asymmetric winding arrangement.

It should be appreciated that to determine the particular manner in which to provide the asymmetric armature windings, one may first analyze the interaction between the stator-pole pairs and the rotor-pole pairs. In particular, the electro-magnetic field distributions of the VPM motor are determined. This It should be done at both no-load and load conditions. In preferred embodiments, the electro-magnetic field distributions of the VPM motor are first determined under no-load conditions and are then determined under load conditions.

The electromagnetic field distributions may be determined using conventional techniques. For example, commercially available finite element method (FEM) software, JMAG-Designer 17.0, JSOL Corporation, Tokyo, Japan may be used to provide a motor performance analysis and verify the reliability of electromagnetic field analysis.

The particular asymmetric winding arrangement with which to provide the armature windings may then be selected so as to promote a torque ripple which is relatively small compared with VPM motors having a similar structure (e.g. one rotor, one stator, three-phase armature windings and similar pole topology). In embodiments, the armature winding may be based upon an overlapping-winding arrangement. In embodiments, the VPM motor can employ a concentrated-winding arrangement to improve (at least in some respects) the motor performance compared with motor performance achieved with an overlapping arrangement. In embodiments, the VPM motor can employ a toroidal-winding arrangement.

The particular number of stator teeth or magnets to use in any particular application are selected to suit the needs of the particular application. To improve (and ideally optimize) VPM motor characteristics some parameters, including but not limited to, stator tooth width Wₜ, stator yoke width W_{y}, motor outer radius rₒᵤₜ, motor inner radius rᵢₙ PM height h_{PM}, PM pole pitch β_{PM}, pole pitch β_{P} and airgap length are selected.

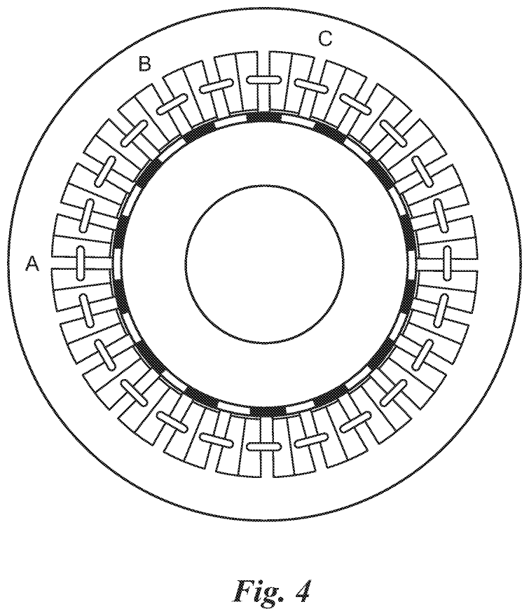

Referring now to FIG. 4, a Vernier permanent-magnet (VPM) motor 40 includes an inner rotor 42, a stator 44, an arrangement (or array) of permanent magnets (generally denoted 46) disposed on said stator 44, three-phase armature windings 48a-48d, 50a-50d, 52a-52d.

The illustrative embodiment of FIG. 4 includes twenty-eight (28) magnets and a 24/14 pole topology (twenty-four-stator-slot/fourteen-rotor-pole-pair topology). The armature windings are installed based upon an asymmetric winding arrangement.

By using the concepts described herein, a VPM motor having an asymmetric armature winding is provided. Such a VPM motor has a torque ripple characteristic which is relatively low compared with the torque ripple characteristic of a conventional VPM motor.

Having described preferred embodiments, which serve to illustrate various concepts, structures and techniques, which are the subject of this patent, it will now become apparent that other embodiments incorporating these concepts, structures and techniques may be used. Accordingly, it is submitted that the scope of the patent should not be limited to the described embodiments but rather should be limited only by the spirit and scope of the following claims. Accordingly, other embodiments are within the scope of the following claims.

What is claimed is:

1. a Vernier permanent-magnet (VPM) motor comprising:
a rotor;
a stator disposed proximate the rotor;
an array of permanent magnets disposed on one of said stator and said rotor;
armature windings coupled to said stator with said armature windings having an asymmetric winding arrangement.

2. The VPM motor of claim 1 wherein said rotor is an inner rotor.

3. The VPM motor of claim 2 wherein said array of permanent magnets are disposed on said stator.

4. The VPM motor of claim 3 wherein said armature windings are provided as three-phase armature windings having an asymmetric winding arrangement.

5. The VPM motor of claim 3 wherein said VPM motor is provided having an N/M pole topology where N and M are both integers greater than 2.

6. The VPM motor of claim 3 wherein said VPM motor is provided having a twelve-stator-slot/seven-rotor-pole-pair topology.

7. The VPM motor of claim 3 wherein said VPM motor is provided having a twenty-four-stator-slot/fourteen-rotor-pole-pair topology.

8. The VPM motor of claim 4 wherein said armature winding is provided as an overlapping-winding arrangement.

9. The VPM motor of claim 1 wherein said rotor is an outer rotor.

10. The VPM motor of claim 8 wherein said array of permanent magnets are disposed on said stator.

11. The VPM motor of claim 9 wherein said armature windings are provided as three-phase armature windings having an asymmetric winding arrangement.

12. The VPM motor of claim 10 wherein said VPM motor is provided having an N/M pole topology where N and M are both integers greater than 2.

13. The VPM motor of claim 10 wherein said VPM motor is provided having a twelve-stator-slot/seven-rotor-pole-pair topology.

14. The VPM motor of claim 10 wherein said VPM motor is provided having a twenty-four-stator-slot/fourteen-rotor-pole-pair topology.

15. The VPM motor of claim 10 wherein said armature winding is provided having a concentrated-winding arrangement.
